(19) United States
(12) Patent Application Publication
(10) Pub. No.: US 2011/0137509 A1
(43) Pub. Date: Jun. 9, 2011

(54) METHOD AND DEVICE FOR ERROR DIAGNOSIS IN AN ENGINE SYSTEM WITH VARIABLE VALVE CONTROLS

(76) Inventor: Ipek Sarac, Stuttgart (DE)

(21) Appl. No.: 12/937,064

(22) PCT Filed: Apr. 3, 2009
(86) PCT No.: PCT/EP09/54031

§ 371 Date: Feb. 17, 2011

(30) Foreign Application Priority Data
Apr. 9, 2008 (DE) 10 2008 001 099.5

(51) Int. Cl. G01M 15/04; G01M 15/10

(52) U.S. Cl. 701/29; 73/114.37; 73/114.76

(57) ABSTRACT

A method is described for diagnosing the functioning of one or more variably triggerable intake valves and/or exhaust valves in an internal combustion engine, including the following steps:—determining a modeled pressure value which provides a pressure value in an air system of the internal combustion engine, the pressure variation model describing a pressure variation of an error-free internal combustion engine as a function of the operating point; providing a value for the actual instantaneous pressure in the air system; ascertaining a deviation variable as a function of the modeled pressure value and a value for the actual pressure in the air system; detecting an error in the functioning of the intake valve and/or the exhaust valve as a function of the deviation variable.

### FIELD OF THE INVENTION

The present invention relates to a method and a device for diagnosing the functioning of intake and exhaust valves of cylinders of an internal combustion engine by monitoring the intake manifold pressure.

### BACKGROUND INFORMATION

Intake manifold pressure sensors are used to detect erroneous function behavior of intake valves in an internal combustion engine. The variation of the intake manifold pressure is transformed into a frequency domain and detected by observing the absence of a harmonic when an error is detectable in switching one of the intake valves. However, this procedure is not suitable for detecting when and on which of the valves an error has occurred in an internal combustion engine having variably controllable intake and exhaust valves.

An electrohydraulic valve system (EHVS) for use in an internal combustion engine includes valves having hydraulic actuators on the intake side both for intake of an air-fuel mixture into the cylinder and on the exhaust side for discharge of exhaust gas into an exhaust gas line. The electrohydraulic valves offer the possibility of separate and completely variable triggering of the intake and exhaust valves, so it is possible to trigger each valve at an arbitrary point in time using a variable and adjustable rise time for the opening and closing. A wide range of combustion strategies may therefore be implemented for the operation of the internal combustion engine.

Electrohydraulic valves usually do not include a device for detecting the actual adjustment state, for example, the valve lift. It is therefore impossible to obtain a direct feedback indicating the adjustment state or providing information about whether the particular valve is in an opened or closed state.

To check the valves for errors, a method for diagnosing the functioning of the valves is therefore required. A diagnosis of the actuators may be achieved by providing position sensors on each actuator. However, this approach greatly increases the cost of the overall system. It is therefore necessary to propose alternative methods and to use, which may be indirectly, other sensors, which are already present in the engine system and are needed for other purposes.

An object of the exemplary embodiments and/or exemplary methods of the present invention is therefore to provide a method and a device for diagnosing errors of variably triggerable valves of an internal combustion engine, the diagnosis being performed without sensors for checking the valve lift of the valves. Another object of the exemplary embodiments and/or exemplary methods of the present invention is to identify the type of error when an error is detected in an intake valve or an exhaust valve.

### SUMMARY OF THE INVENTION

This object may be achieved by the method as described herein and by the device as recited herein.

Advantageous embodiments of the present invention are defined in the further descriptions herein.

According to a first aspect, a method is provided for diagnosing the functioning of multiple variably triggerable intake valves and/or exhaust valves in an internal combustion engine. This method includes the following steps:
determining a modeled pressure value, which provides a value for a pressure in an air system of the internal combustion engine, on the basis of a pressure variation model, where the variation model describes a pressure variation of an error-free internal combustion engine as a function of the operating point;
providing a value for the actual instantaneous pressure in the air system;
ascertaining a deviation variable as a function of the modeled pressure value and the actual pressure value in the air system;
detecting an error in triggering of the intake valves and/or exhaust valves as a function of the deviation variable.

Since the valves are part of the air system of the internal combustion engine, their errors have a direct effect on the sensors in the air system, for example, the air flow sensor and the intake manifold pressure sensor. The effects of the function of the valves on other sensors (e.g., camshaft angle, lambda sensor) would require additional information about other engine actuators and their states, so that in the above-mentioned method a pressure variation model, which uses the air intake sensors as input variables, reduces the complexity in error detection of errors of the functioning of the valves. For this purpose, the pressure variation in the air system for a properly functioning internal combustion engine is modeled, and the resulting modeled pressure for an operating point is compared with the actual pressure in the air system. An error in the valve triggering is detected on the basis of the deviation in the pressures from one another. In addition, a plausibility check may also be performed on the valve position due to the error, this valve position being detected by position sensors mounted on the valves.

In addition, the error is detectable as a function of the deviation variable and as a function of a threshold value, which is a function of the rotational speed of the internal combustion engine.

According to one specific embodiment, the type of error is detected as a function of the position of a certain time period during which the error is detected with the aid of the deviation variable.

The time period may be defined as the time range between the times of successive triggerings of the individual valves, so that an error is detected in the intake valve and/or exhaust valve, whose triggering marks the start of the time period during which the error is detected as a function of the deviation variable.

According to one specific embodiment, the pressure variation model may be used as a function of a learning signal and as a function of the value of the actual instantaneous pressure in the air system during operation of an error-free internal combustion engine.

The pressure variation model is able to simulate the periodic pressure variation in the air system on the basis of a Fourier equation using Fourier coefficients, the Fourier coefficients being ascertained on the basis of the measured pressure value.

According to another aspect, a device for diagnosing the functioning of multiple variably triggerable intake valves and/or exhaust valves in an internal combustion engine is provided. The device includes:
a modeling unit for determining a modeled pressure value, which provides a value for a pressure in an air system of the internal combustion engine, on the basis of a pressure variation model, the pressure variation model describing a pressure variation of an error-free internal combustion engine as a function of the operating point;
a unit for ascertaining a deviation variable as a function of the modeled pressure value and the actual pressure value in the air system;
an evaluation unit for detecting an error in the triggering of the intake and/or exhaust values as a function of the deviation variable.

According to one specific embodiment, a switch may be provided to supply the actual instantaneous pressure value in the air system as a function of a learning signal of the modeling unit, so that the pressure variation model is learned during operation of an error-free internal combustion engine as a function of the measured pressure values.

According to another aspect, a computer program is provided, containing a program code executing the above method when executed on a data processing unit.

Exemplary and specific embodiments of the present invention are explained in greater detail below on the basis of the accompanying drawings.

### BRIEF DESCRIPTION OF THE DRAWINGS

FIG. 1 shows a schematic cross-sectional representation of an air supply part of a cylinder having an intake valve.

FIG. 2 shows a top view of an internal combustion engine having an air supply and exhaust gas removal.

FIG. 3 shows a representation of the possible degrees of freedom for freely triggerable valves in an engine system.

FIG. 4 shows a schematic block diagram to illustrate the method according to the present invention.

FIG. 5 shows a signal-time diagram to illustrate the pressure variation measured by the pressure sensor and the adjusting lengths (lift) of the individual valves.

FIG. 6 shows the pressure variation of the intake manifold pressure, measured by the pressure sensor, and a signal model, which indicates the first six harmonics of the Fourier series of the modeled intake manifold pressure variation, and the curve of the error between the modeled signal and the actual pressure variation.

FIG. 7 shows a schematic diagram of the actual pressure variation and the modeled pressure variation using the first six harmonics of the Fourier series in an error case, in which the exhaust valve on the first cylinder does not open, and shows the curve of the squared error between the actual pressure variation and the modeled pressure variation.

FIG. 8 shows the curve of the squared and filtered error between the modeled signal and the faulty signal, where the exhaust valves of the first and the third cylinder do not open.

FIG. 9 shows the variation of the actual pressure in the intake manifold and of the modeled pressure signal as well as the variation of the squared error.

FIG. 10 shows the curve of the squared and filtered error between the modeled pressure signal and a faulty pressure signal for an error of the intake valve of the first cylinder and also for an error of the intake valve of the third cylinder.

FIG. 11 shows the curve of the squared and filtered error between the modeled pressure signal and the actual pressure signal containing the error for faulty intake and exhaust valves of the first and third cylinders.

FIG. 12 shows the curve of the actual pressure signal and the modeled pressure signal in the error case in which one intake valve opens later than expected.

FIG. 13 shows the curve of the pressure signal and of the modeled signal in the error case, in which the exhaust valve of the first cylinder closes later than expected.

### DETAILED DESCRIPTION

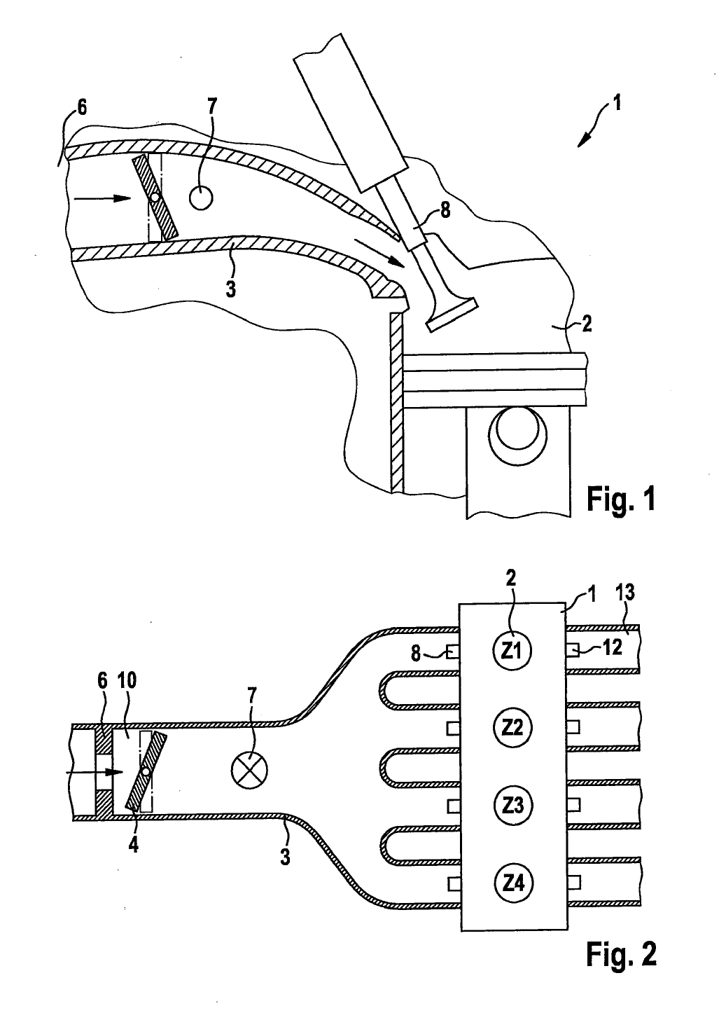

FIG. 1 shows a cross-sectional view of an air supply system for a single cylinder 2 of an internal combustion engine 1. The air supply system includes an intake manifold 3, in which a throttle valve 4 is situated to control the air supply to cylinder 2 via intake manifold 3.

An air flow sensor 6 is usually provided upstream from throttle valve 4 to detect the air flow into cylinder 2 of internal combustion engine 1. In addition, a pressure sensor 7 is provided in the area downstream from throttle valve 4 to detect the air pressure in intake manifold 3 as a function of the position of throttle valve 4. Air in intake manifold 3 is allowed to enter the combustion chamber of cylinder 2 out of intake manifold 3 via a corresponding intake valve 8, as a function of the opening state of intake valve 8.

FIG. 2 shows a top view of the engine system having internal combustion engine 1, which includes four cylinders 2. The cylinders are labeled Z1-Z4 in the order of their positions in the engine block. The firing sequence of cylinders 2 corresponds to Z1-Z3-Z2-Z4. The engine system includes a general air supply 10, in which throttle valve 4 is situated. Air flow sensor 6, which is able to detect the instantaneous pressure in intake manifold 3, is situated upstream from throttle valve 4, and an intake manifold pressure sensor 7 is provided downstream from throttle valve 4.

Four cylinders 2 of internal combustion engine 1 are each provided with an intake valve 8 and an exhaust valve 12. Intake manifold 3 branches off to supply air to corresponding intake valves 8 of particular cylinder 2. Exhaust valves 12 of cylinder 2 discharge the combustion exhaust gas from cylinders 2 into an exhaust line 13. In the engine system shown here, intake valves 8 and exhaust valves 12 which are used are freely triggerable valves whose opening states may be adjusted variably.

FIG. 3 shows various curves of the flow-through cross section of a freely triggerable valve to illustrate the triggerability of intake valves 8 and exhaust valves 12 over a certain period of time, during which the valve is opened and then closed again. The multiple degrees of freedom in triggering such a valve are apparent. It is possible to control the size of the throughput cross section in the open state, the speed at which the valve is opened or closed (characterized by the rate of increase in the throughput cross section over time), as well as the opening and closing times of the valve.

These degrees of freedom may be utilized by suitable triggering of the valves. If there are deviations between the triggering of the valve and the behavior of the valve, this is an error case. Some error cases in which the behavior of the valve does not correspond to the desired behavior may be serious for the operation of such an engine system in which intake valves 8 and exhaust valves 12 are triggerable variably and independently of one another.

The method described below makes it possible to detect errors in the intake and exhaust valves in the engine system described above when intake and exhaust valves 8, 12 are not opened at all when there is corresponding triggering, intake valve 8 is opened too late, or exhaust valve 12 is closed too late (while the intake valve is open).

An error in a valve is detected when the pressure variation in the intake manifold deviates from a modeled pressure variation. The modeled pressure variation corresponds to a pressure variation which would prevail in the ideal case if the behavior of intake valve 8 and exhaust valve 12 corresponds to the desired behavior in known air system dynamics. The pressure variation in the intake manifold may be modeled, for example, by plotting a pressure variation of an internal combustion engine 1 having error-free intake valves 8 and exhaust valves 12. The resulting pressure variation is analyzed next with the aid of a Fourier analysis. Since the pressure variation in intake manifold 3 is a periodic signal, it may be represented as follows:

$${P}_{man} ( t ) = \frac{{a}_{0}}{2} + {\sum }_{n = 1}^{N} {a}_{n} \cdot cos ( n {\overline{ω}}_{0} t ) + {\sum }_{n = 1}^{N} {b}_{n} \cdot sin ( n {\overline{ω}}_{0} t )$$

where a₀ corresponds to a zero-frequency component, which is needed for approximating the modeled signal, P_{mod} corresponds to the modeled pressure signal for the intake manifold pressure, N corresponds to the number of the harmonic, ω corresponds to the angular frequency of the fundamental oscillation, and aₙ and bₙ correspond to the odd and even Fourier coefficients. The Fourier coefficients of the above equation may be determined as follows:

$${a}_{0} = \frac{2}{T} \cdot {\int }_{0}^{T} {P}_{man} ( t ) \cdot cos ( n {\overline{ω}}_{0} t ) d t$$

$${b}_{0} = \frac{2}{T} \cdot {\int }_{0}^{T} {P}_{man} ( t ) \cdot sin ( n {\overline{ω}}_{0} t ) d t$$

In this way, corresponding Fourier coefficients aₙ and bₙ for the curve of the pressure signal which form the basis for the modeled pressure signal may be determined with a knowledge of the freedom from errors of intake valves 8 and exhaust valves 12 of an internal combustion engine 1. The pressure signal is thus modeled by determining coefficients aₙ and bₙ. Since the pressure signal curves depend on the operating point of internal combustion engine 1, coefficients aₙ and bₙ must be made to be retrievable, for example, by storing them in an engine characteristics map, so that the intake manifold pressure to be expected for error-free operation is modeled as a function of rotational speed n of internal combustion engine 1, load M of internal combustion engine 1, temperature T of internal combustion engine 1 and other parameters. Depending on the desired accuracy of the intake manifold pressure to be modeled, the number of harmonics (index n) may be selected. In general, good results with the modeled pressure signal variation are already obtained with n=3. A pressure variation model adapted to internal combustion engine 1 and modeling the variation of intake manifold pressure Pₘₐₙ is obtained by using the above equation with the determined coefficients aₙ and bₙ.

In operation of intake valve 8 and exhaust valve 12 with exhaust gas recirculation in partial load operation, which is implemented by an overlap of the opening times of intake valve 8 and exhaust valve 12, feedback of the closing operation of exhaust valve 12 is detectable by evaluating the pressure variation of intake manifold pressure sensor 7. The overlap of the opening times occurs due to early opening of intake valve 8 at a point in time when exhaust valve 12 is still open. In other words, exhaust valve 12 is closed, while intake valve 8 is already open to allow air or an air-fuel mixture to enter cylinder 2. Exhaust gas recirculation is implementable in this way.

Errors in intake valves 8 and exhaust valves 12 are now detected by continuously comparing measured intake manifold pressure Pₘₐₙ prevailing instantaneously in intake manifold 3 with an intake manifold pressure P_{mod} modeled using the equation given above for the pressure variation. Modeled intake manifold pressure P_{mod} takes into account the frequency of the fundamental oscillation as a function of instantaneous rotational speed n of internal combustion engine 1.

In the case of a deviation between the modeled value and the instantaneous pressure value, which is greater than a predefined threshold value, it is possible to determine, on the basis of the position in time of the deviation, on which cylinder 2 the error has occurred and whether the error has occurred at intake valve 8 or exhaust valve 12.

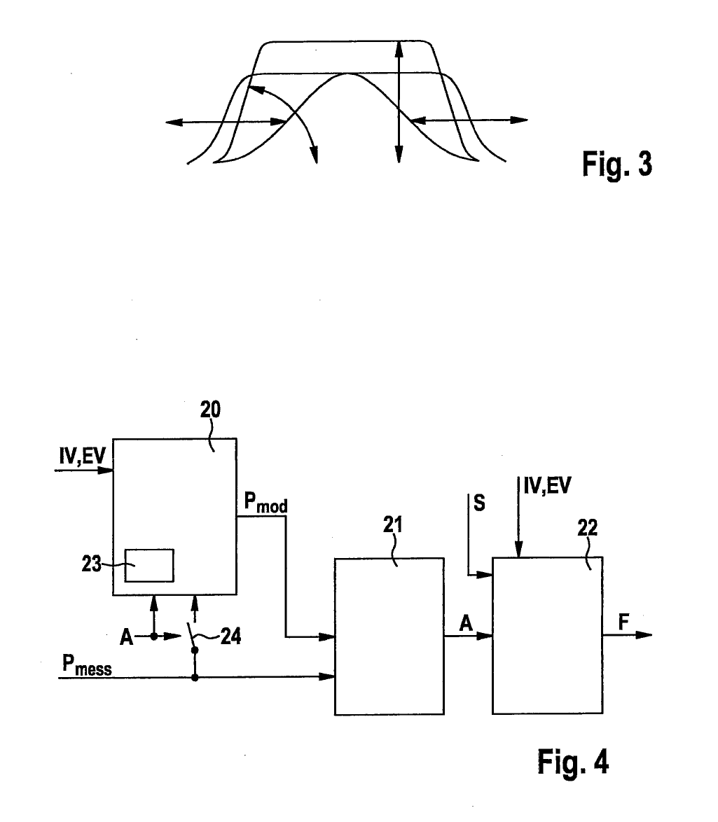

FIG. 4 shows a block diagram to illustrate the diagnostic function. The diagnostic function is implemented with the aid of a modeling unit 20, a comparator unit 21 and an evaluation unit 22. Modeling unit 20 includes an engine characteristics map memory 23 in which Fourier coefficients aₙ and bₙ may be stored. A pressure P_{mod} corresponding to the instantaneous pressure in intake manifold 3 in the case of a properly functioning internal combustion engine 1 may be modeled according to an intake manifold pressure model on the basis of values for the triggering times (opening point in time, opening duration and closing point in time) of intake valve 8 and exhaust valve 12, which are given by parameters EV and IV and are supplied to modeling unit 20. Points in time of successively triggerings of individual valves are defined.

Designations EV and IV about the triggering times of intake valve 8 and exhaust valve 12 are supplied by an engine control unit or the like and are determined as a function of operating point, i.e., as a function of, for example, an engine rotational speed n, an applied load torque M, temperature T of internal combustion engine 1 or of intake manifold 3, so that modeled pressure P_{mod} is ultimately obtained as a variable dependent upon the operating point. Other parameters may also be taken into account. In addition, model pressure P_{mod} may also depend on an operating mode of internal combustion engine 1, for example, on one of the following operating modes: partial load operation, cylinder shutdown, spontaneous ignition operation and the like.

Engine characteristics map memory 23 stores model values of pressure P_{mod} as a function of designations EV, IV about the triggering times of intake valve 8 and exhaust valve 12. Intake manifold pressure sensor 7 detects instantaneous intake manifold pressure Pₘₐₙ. Both modeled intake manifold pressure P_{mod} and measured intake manifold pressure Pₘₐₙ are sent to comparator unit 21, where modeled intake manifold pressure P_{mod} and measured intake manifold pressure Pₘₐₙ are compared with one another. A deviation variable A is determined from modeled intake manifold pressure P_{mod} and measured intake manifold pressure Pₘₐₙ and transmitted to evaluation unit 22. Deviation variable A corresponds to a value for the difference between modeled intake manifold pressure P_{mod} and measured intake manifold pressure Pₘₐₙ. The value for the difference between two intake manifold pressures P_{mod}, Pₘₐₙ may be squared to obtain an absolute value for the difference between intake manifold pressure P_{mod}, Pₘₐₙ as deviation variable A.

An error is detected in evaluation unit 22 when deviation variable A exceeds an amount defined by a threshold value S. Error signal F is then generated, initiating a diagnosis in evaluation unit 22 and/or allowing a plausibility check of position sensors on intake valve 8 and/or exhaust valve 12. Threshold value S may be determined as a function of rotational speed n and/or load torque M of internal combustion engine 1 to take into account the pressure levels occurring at the different operating points.

Evaluation unit 22 continues to receive designations EV, IV about the triggering times for each intake valve 8 and exhaust valve 12, so that the type of error and the location of the error (cylinder 2, to which faulty intake valve 8 or exhaust valve 12 is assigned) may be detected as a function of the instantaneous triggering state of valves 8, 12 and error signal F. Periods of time may be defined in particular by analyzing the periods of time between individual valve triggering changes, for example, opening and closing of one of valves 8, 12 and the opening and closing of one of the next valves 8, 12. If error signal F indicates an error, then valve 8, 12 at which the error has occurred may be identified over the period of time in which the error occurred.

With the aid of a switch 24, actual intake manifold pressure Pₘₐₙ may be sent to modeling unit 20 to undertake learning of engine characteristics map 23 there. Learning occurs by determining Fourier coefficients from the measured values of intake manifold pressure Pₘₐₙ and by assigning Fourier coefficients to the particular operating point or to designations EV, IV about the triggering times of intake valves 8 and exhaust valves 12. The learning may be indicated by learning signal E.

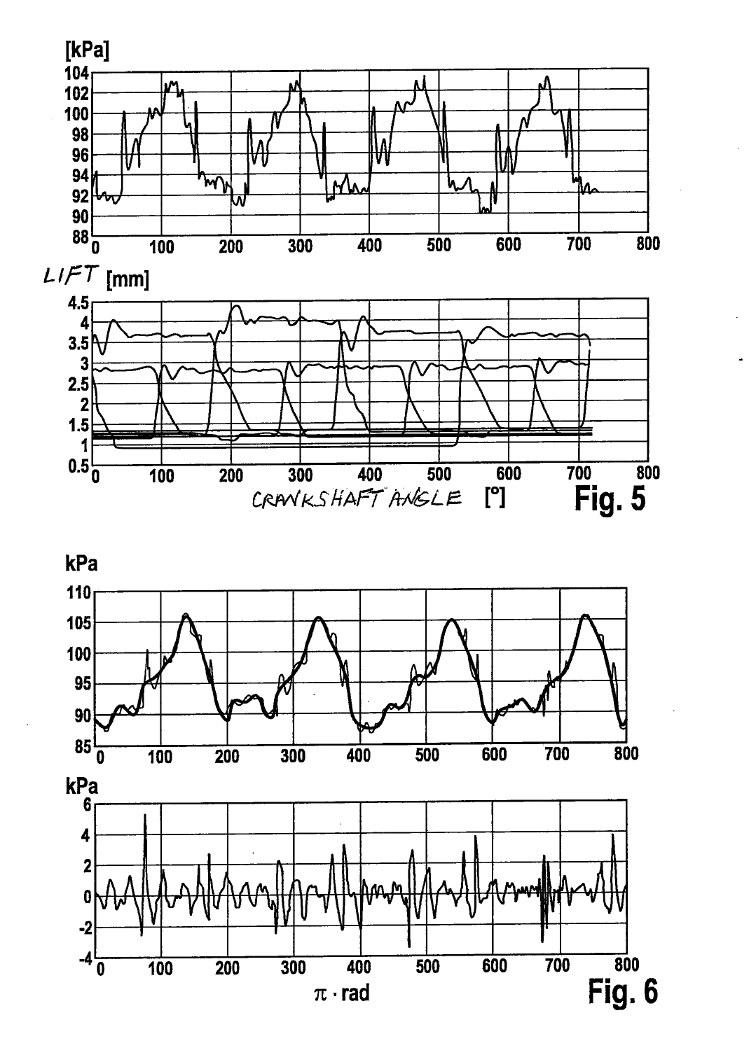

FIG. 5 shows the curves of the measured pressure (upper curve) and valve opening time at a rotational speed of 2000 rpm plotted as a function of the crankshaft angle. Exhaust valves 12 have greater lifts (in mm) than intake valves 8.

In FIG. 6, the variation of measured intake manifold pressure Pₘₐₙ and modeled pressure signal P_{mod} are superimposed on one another in the upper curve. Modeled pressure signal P_{mod} was modeled using n=6, i.e., taking into account six harmonics. The lower curve shows the deviations between modeled pressure signal P_{mod} and actual pressure Pₘₐₙ. In this and all the following figures, curves are plotted not over time but rather over the angle of rotation in π·rad to thereby achieve independence of the rotational speed.

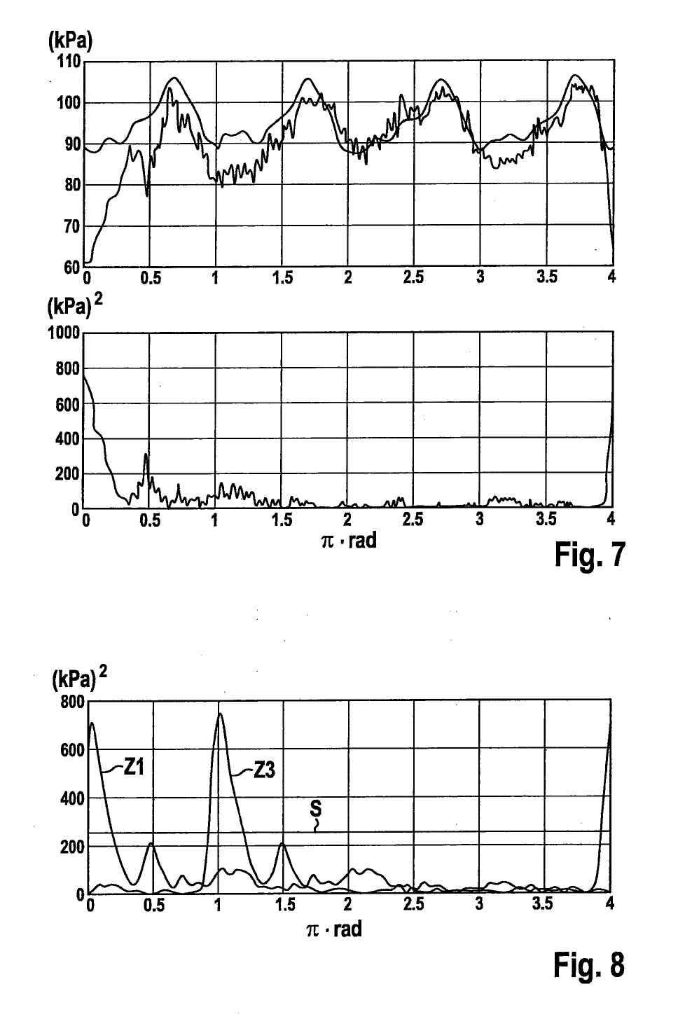

FIG. 7 shows the variation of the intake manifold pressure and of pressure signal P_{mod} which is modeled using the six harmonics in a case in which exhaust valve 12 does not open in first cylinder 2. The lower curve shows the squared deviation between two pressure signals Pₘₐₙ and P_{mod}. Squaring the deviation makes it possible to evaluate the deviation as an absolute value.

As shown in FIG. 8, the squared deviation may be filtered between modeled pressure variation P_{mod} and actual pressure variation Pₘₐₙ. An error in one of valves 8, 12 may be detected if the value thereby ascertained exceeds predefined threshold value S. Threshold value S, amounting to approximately 250 kPa² in the example in FIG. 8, may be selected as a function of rotational speed and is defined for a rotational speed of 3000 rpm in the example shown here. The variation of the squared deviation shown in FIG. 8 signals that an intake valve 8 for cylinder Z1 and cylinder Z3 is not opening. This is detected by evaluation unit 22 by the fact that the deviation occurs immediately after the triggering to open the intake valves of cylinders Z1 and Z3.

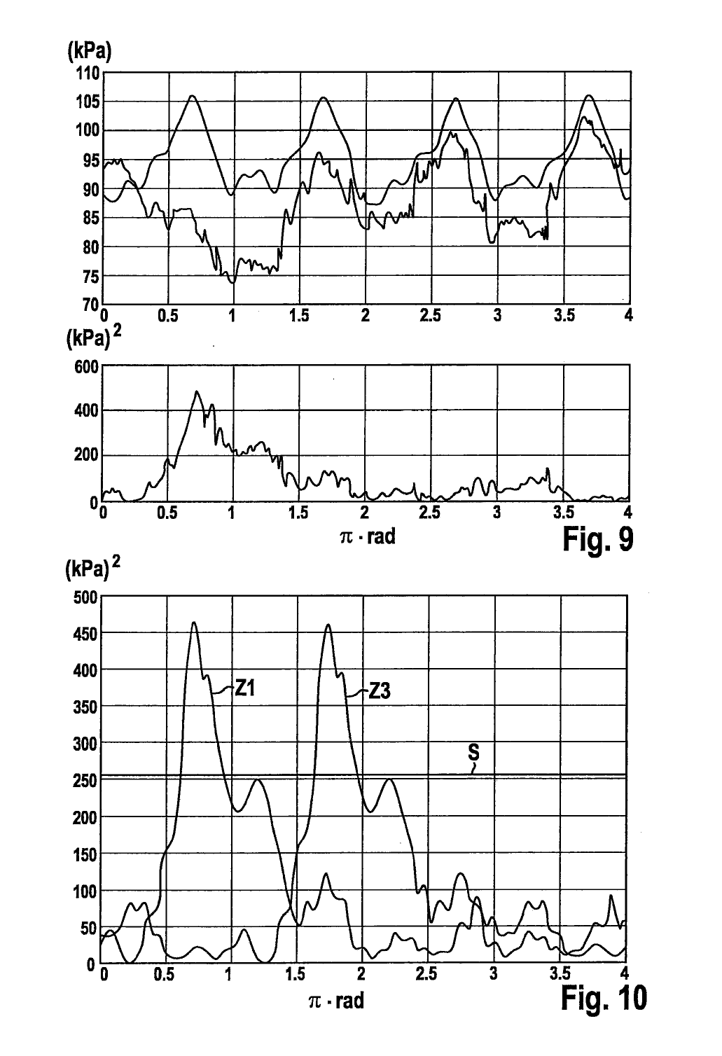

FIG. 9 shows the variations of modeled intake manifold pressure P_{mod} and actual intake manifold pressure Pₘₐₙ (upper curve) and the corresponding squared deviations in the lower curve. The error case presented here corresponds to an error in which exhaust valve 12 on first cylinder Z1 does not open. This is detected by evaluation unit 22 due to the fact that the deviation occurs immediately after the triggering to close the exhaust valve of cylinder Z1.

FIG. 10 shows the squared and filtered deviations between the variation of modeled intake manifold pressure P_{mod} and the variation of actual pressure Pₘₐₙ for the error cases in which intake valves 8 of cylinders Z1 and Z3 do not open. The threshold at which an error should be detected is approximately 250 kPa² at a rotational speed of 3000 rpm.

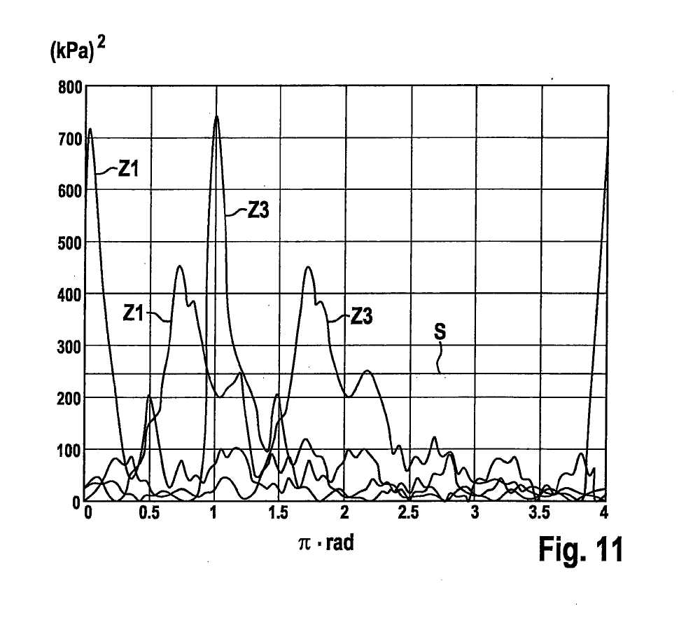

FIG. 11 shows several variations for squared and filtered deviations between the modeled pressure variation and the actual pressure variation for faulty intake valves 8 of cylinder Z1 and cylinder Z3 and faulty exhaust valves 12 of cylinder Z1 and cylinder Z3.

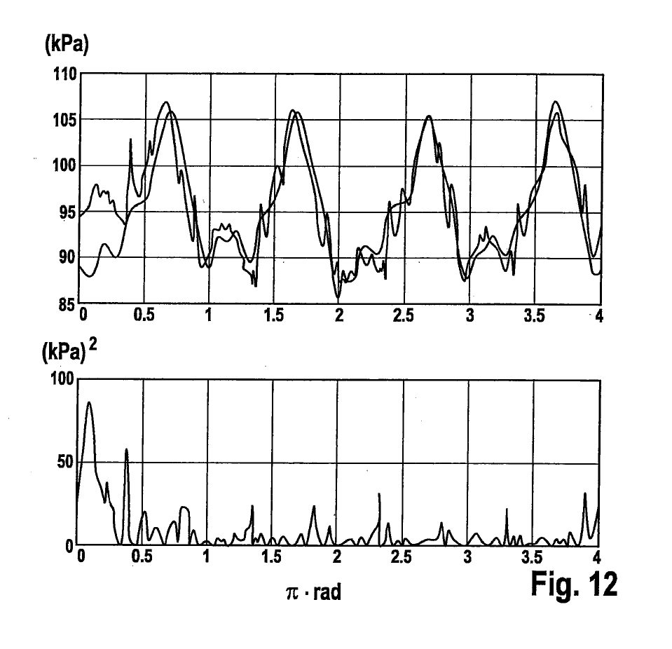

FIG. 12 shows the variations of modeled intake manifold pressure P_{mod} and of actual intake manifold pressure Pₘₐₙ in an error case in which one intake valve 8 for first cylinder Z1 opens later than expected. The lower curve shows the squared deviation between the two pressure curves.

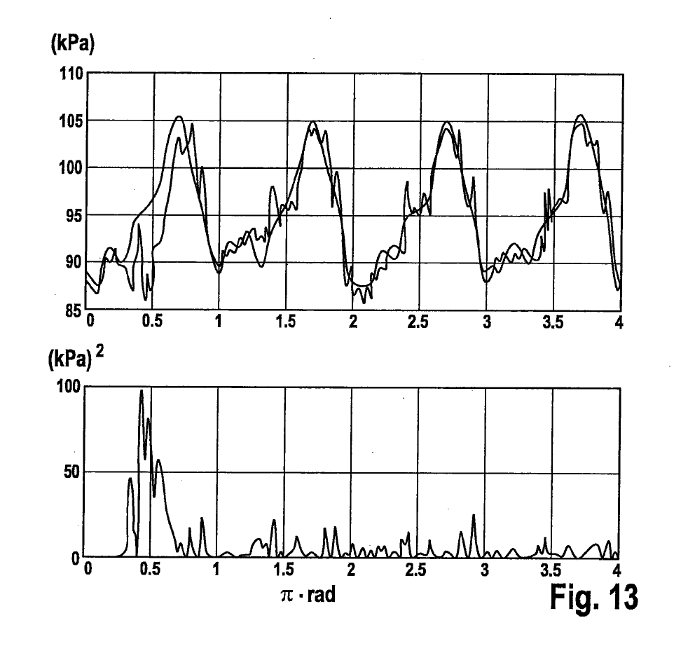

FIG. 13 shows the measured pressure variation and the modeled pressure variation in the error case in which exhaust valve 8 of first cylinder Z1 closes later than desired and the squared deviation between the pressure variations is represented in the lower curve accordingly.

The diagrams in FIG. 5 through FIG. 13 and in particular the diagrams in FIG. 11 show that for each error case there is a deviation between the variation of modeled intake manifold pressure P_{mod} and that of actual intake manifold pressure Pₘₐₙ at a position in time, which may be assigned unambiguously to a certain valve, i.e., intake valve 8 or exhaust valve 12, and a certain cylinder Z1 through Z4. With knowledge of the time ranges in which the pressure variation in the intake manifold is determined to a significant extent by a certain intake valve 8 or exhaust valve 12, a malfunction of corresponding valve 8, 12 is determinable with a high reliability. The time ranges are defined by the periods of time between two successive valve triggerings in particular, each resulting in opening or closing of valves 8, 12.

1-9. (canceled)

10. A method for diagnosing a function of at least one of a variably triggerable intake valve and a variably triggerable exhaust valve in an internal combustion engine, the method comprising:
determining a modeled pressure value, which supplies a value for a pressure in an air system of the internal combustion engine based on a pressure variation model, the pressure variation model describing a pressure variation of an error-free internal combustion engine as a function of the operating point;
providing an actual instantaneous pressure value in the air system;
ascertaining a deviation variable as a function of the modeled pressure value and the actual pressure value in the air system; and
detecting an error in the functioning of the at least one of the intake valve and the exhaust valve as a function of the deviation variable.

11. The method of claim 10, wherein the error is detected as a function of the deviation variable and as a function of a threshold value depending on at least one of a rotational speed and a load torque of the internal combustion engine.

12. The method of claim 10, wherein the type of error is determined as a function of the location of a certain period of time in which the error is detected with the aid of the deviation variable.

13. The method of claim 12, wherein the period of time is defined as the time range between the times of successive triggerings of the individual valves, and wherein an error of the at least one of the intake valve and the exhaust valve whose triggering marks the start of the period of time during which the error is detected as a function of the deviation variable.

14. The method of claim 10, wherein the pressure variation model is learned as a function of a learning signal and as a function of the value of the actual instantaneous pressure in the air system during operation of an error-free internal combustion engine.

15. The method of claim 14, wherein the pressure variation model simulates the periodic variation of the pressure in the air system based on a Fourier equation using Fourier coefficients, and wherein the Fourier coefficients are ascertained based on the measured pressure value.

16. A device for diagnosing the functioning of at least one of multiple variably triggerable intake valves and variably triggerable intake valves in an internal combustion engine, comprising:
a modeling unit for determining a modeled pressure value, which supplies a pressure value in an air system of the internal combustion engine, based on the pressure variation model, wherein the pressure variation model describes a pressure variation of an error-free internal combustion engine as a function of the operating point;
an ascertaining unit for ascertaining a deviation variable based on the modeled pressure value and the actual pressure value in the air system; and
an evaluation unit for detecting an error in the functioning of the at least one of the intake valve and the exhaust valve depending on the deviation variable.

17. The device of claim 16, further comprising:
a switch to supply the measured pressure value as a function of a learning signal of the modeling unit, so that the pressure variation model is learned as a function of the actual instantaneous pressure value in the air system during operation of an error-free internal combustion engine.

18. A computer readable medium having a computer program, which is executable by a processing unit, comprising:
a program code arrangement having program code for diagnosing a function of at least one of a variably triggerable intake valve and a variably triggerable exhaust valve in an internal combustion engine, by performing the following:
determining a modeled pressure value, which supplies a value for a pressure in an air system of the internal combustion engine based on a pressure variation model, the pressure variation model describing a pressure variation of an error-free internal combustion engine as a function of the operating point;
providing an actual instantaneous pressure value in the air system;
ascertaining a deviation variable as a function of the modeled pressure value and the actual pressure value in the air system; and
detecting an error in the functioning of the at least one of the intake valve and the exhaust valve as a function of the deviation variable.
